(19) United States
(12) Patent Application Publication
(10) Pub. No.: US 2017/0164784 A1
(43) Pub. Date: Jun. 15, 2017

(54) Rotisserie Grilling System

(71) Applicants: Randy Rummel, Huntington Beach, CA (US); Daniel Nichols, Huntington Beach, CA (US); Mark Steinman, Huntington Beach, CA (US)

(72) Inventors: Randy Rummel, Huntington Beach, CA (US); Daniel Nichols, Huntington Beach, CA (US); Mark Steinman, Huntington Beach, CA (US)

(21) Appl. No.: 14/967,159

(22) Filed: Dec. 11, 2015

(51) Int. Cl. A47J 37/07; A47J 37/04

(52) U.S. Cl. CPC A47J 37/0718; A47J 37/041

(57) ABSTRACT

A method and apparatus can include: a body having an inner surface and a bottom floor; a vertical basket having a spacer and an exposed perforated bottom the perforated bottom exposed from the bottom floor of the body by the spacer, the vertical basket further including a vertical grating and a solid back, the vertical basket for holding an ignited fuel source and radiating heat through the grating; and a skewer parallel to the grating, the skewer including a bracket for securing a food product to the skewer.

### TECHNICAL FIELD

This disclosure relates to grilling technology, more particularly grilling technology implementing a rotisserie and vertical heat source.

### BACKGROUND

A common method of cooking foods is grilling which is also known as barbecuing. A heat source can be placed below or next to food that is being cooked. Typically the heat source can produce a radiant heat, and a convection heat along with smoke that can flavor the food.

In one type of grilling, a rotating skewer can be used to rotate the food over an ignited fuel source such as wood or charcoal. The rotating skewer can form a rotisserie. The heat sources is typically enclosed beneath the skewer. Most of these grilling appliances have hinged covers that can be opened and closed over the grilling sections, some are built without any lids or covers. The convection gasses and smoke typically rises up through an internal volume of the grill and exit through a top vent in the hinged cover.

These grilling appliances are commonly used for residential or commercial restaurant use and can be used in an indoor or outdoor area. These appliances are intended for the cooking of foods such as meats and vegetables.

In the development of grilling appliances, many problems have arisen. When skewer mounted food is positioned above the sources of heat, oils and juices cook out of the food products and can drip downward onto the ignited fuel source. This can causes grease fires or “flare-ups” which can burn the food, or deposit black smoke deposits on the food products which negatively affects their taste.

Solutions to these problems have been long sought but prior developments have not taught or suggested any complete solutions, and solutions to these problems have long eluded those skilled in the art. Thus there remains a considerable need for devices and methods of preventing uncontrolled flareups and providing safer and more effective grilling appliances.

### SUMMARY

A rotisserie grilling system and methods, preventing uncontrolled flare-ups and providing safer and more effective grilling appliances is disclosed. The rotisserie grilling system and methods can include: a body having an inner surface and a bottom floor; a vertical basket having a spacer and an exposed perforated bottom the perforated bottom exposed from the bottom floor of the body by the spacer, the vertical basket further including a vertical grating and a solid back, the vertical basket for holding an ignited fuel source and radiating heat through the grating; and a skewer parallel to the grating, the skewer including a bracket for securing a food product to the skewer.

Some embodiments of the grilling system provide a vertical receptacle for the hot fuel source that is out of the path of oils and juices that can drip from the cooking process, uncontrolled flare ups are avoided yielding better cooking results and less labor involved with cooking the food product since uncontrolled flare-ups from a bottom heat source are mitigated.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The grilling system is illustrated in the figures of the accompanying drawings which are meant to be exemplary and not limiting, and in which:

FIG. 1 is a side view of an embodiment of a grilling system.

FIG. 2 is an isometric view of the grilling system of FIG. 1 in a grilling phase of operation.

FIG. 3 is a method of manufacturing the grilling system.

### DETAILED DESCRIPTION

In the following description, reference is made to the accompanying drawings that form a part hereof, and in which are shown by way of illustration, embodiments in which the grilling system may be practiced. It is to be understood that other embodiments may be utilized and structural changes may be made without departing from the scope of the grilling system.

When features, aspects, or embodiments of the grilling system are described in terms of steps of a process, an operation, a control flow, or a flow chart, it is to be understood that the steps can be combined, performed in a different order, deleted, or include additional steps without departing from the grilling system as described herein.

The grilling system is described in sufficient detail to enable those skilled in the art to make and use the grilling system and provide numerous specific details to give a thorough understanding of the grilling system; however, it will be apparent that the grilling system may be practiced without these specific details. In order to avoid obscuring the grilling system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGs.

As used herein, the term system is defined as a device or method depending on the context in which it is used. For expository purposes, the term “horizontal” as used herein is defined as a plane parallel to the top plane or surface of the body of the grilling system, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane.

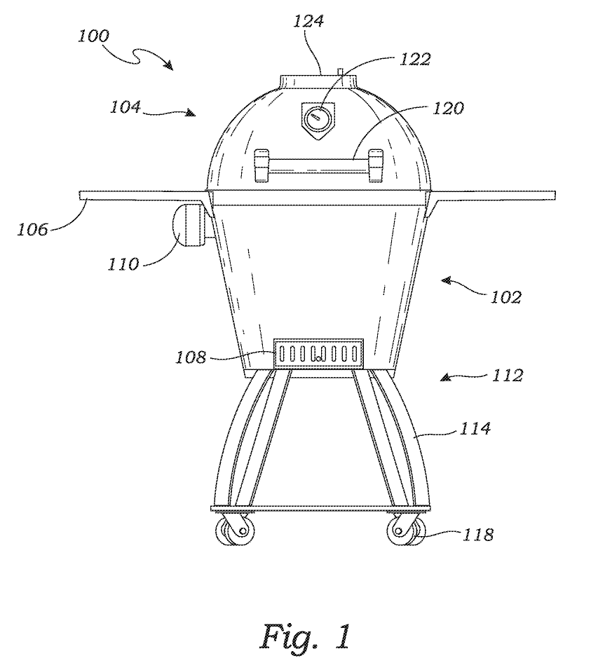

Referring now to FIG. 1, therein is shown a side view of an embodiment of a grilling system 100. The grilling system 100 is depicted having a body 102 with a hood covering 104 coupled thereto. The hood covering 104 can be moveable and can hinge to provide access inside the grilling system 100.

Beside the hood covering 104 and extending out from the body 102 are food preparation extensions 106. Near the bottom of the body 102, the body is depicted as having adjustable input vents 108 for controlling the amount of air that can be input into the grilling system 100.

The air allowed into the grilling system 100 from the adjustable input vents 108 can control the amount of heat generated within the grilling system 100. Below the food preparation extensions 106 and coupled to the body 102, a rotisserie motor 110 is mounted.

It is contemplated that the rotisserie motor 110 can be coupled to the body 102 of the grilling system 100 and can be an electrically driven motor such as a DC motor or an AC motor. The rotisserie motor 110 can be coupled to a drive mechanism including gearing.

The body 102 can be attached to a cart 112. The cart 112 can be comprised of legs 114 coupled to a base 116. The base 116 can be coupled to wheels 118.

The hood covering 104 can include a handle 120 in the front of the hood covering 104. The handle 120 can be used to open the hood covering 104 and separate it from the body 102.

The hood covering 104 can further include a thermometer 122 on the hood covering 104 above the handle 120. At the top of the hood covering 104, a vent 124 is depicted. The vent 124 can allow hot gasses and smoke to be exhausted from the grilling system 100.

While the grilling system 100 is depicted with the body 102 being in a rounded configuration, other configurations are contemplated and those having ordinary skill in the art would recognize that other configurations of the body 102 could be implemented without deviating from the grilling system 100. As an example, other contemplated embodiments of the grilling system 100 can include a square or rectangular in shape body 102 and can be implemented with or without the hood covering 104. The grilling system 100 is contemplated to be enable rotisserie cooking in outdoor charcoal grills and smokers for both residential and commercial use.

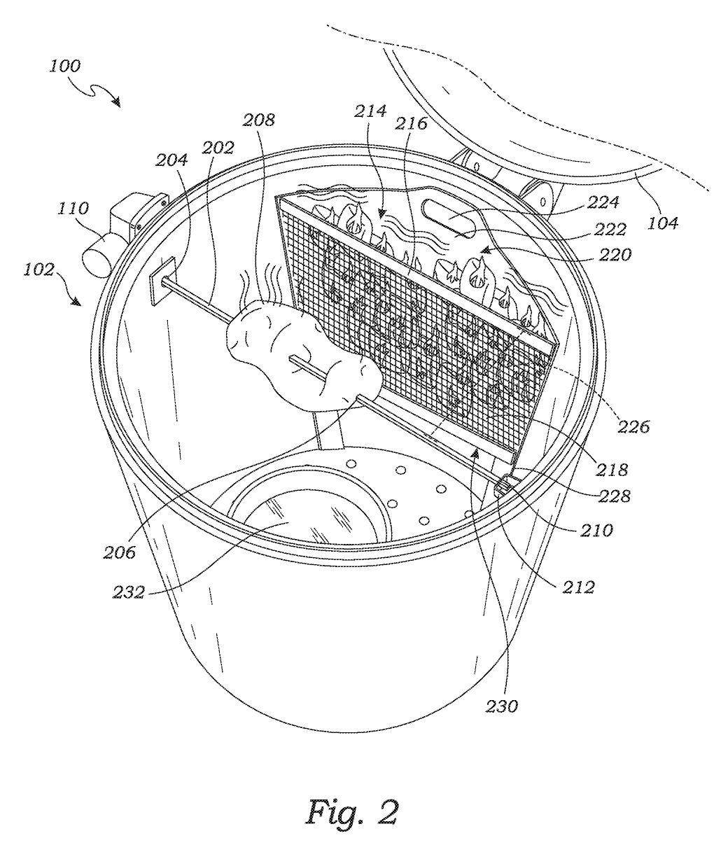

Referring now to FIG. 2, therein is shown an isometric view of the grilling system 100 of FIG. 1 in a grilling phase of operation. The grilling system 100 is depicted having the hood covering 104 in an open configuration and hinged up from the body 102.

The rotisserie motor 110 is depicted mounted to the side of the body 102. A skewer 202 is depicted extending through a hole 204 in the body 102 and coupled to the rotisserie motor 110. The skewer 202 is shown to have a bracket 206 for securing a food product 208.

It is contemplated that the bracket 206 could be a clamp or a fork for securing the food product 208. The skewer 202 is shown to have a groove 210 resting in a guide 212 on the end of the skewer 202 opposite the hole 204.

It is contemplated that the skewer 202 can include two of the grooves 210, on each end of the skewer 202 and can be removable from the rotisserie motor 110. When the skewer 202 is removed, the food product 208 can be secured on the skewer 202 and the skewer 202 coupled to the rotisserie motor 110 on one end and the groove 210 placed in the guide 212 on the other end.

The guide 212 can be a semi-circular support that rides within the groove 210 of the skewer 202 preventing the skewer 202 from moving laterally while allowing the skewer 202 to move rotationally. The rotisserie motor 110 can rotate the skewer 202 and thereby provide even exposure of the food product 208 to an ignited fuel source 214.

The ignited fuel source 212 can be a charcoal or wood fuel source contained within a vertical basket 216. The vertical basket 216 can be a metal basket having a grating 218 near a front side facing the food product 208 for allowing heat from the ignited fuel source 212 to radiate out to the food product 208.

The grating 218 can be a flat surface facing the food product 208 on one side of the vertical basket 216. Other sides of the vertical basket 216 can be solid and can conform to the inner surface of the body 102. The vertical basket 216 is depicted with an open top 220 for ease of loading the ignited fuel source 212 before use.

Near the open top 220, the vertical basket 216 can include a hanging opening 222. The hanging opening 222 can mate to a hanger protrusion 224 on the inner surface of the body 102. The hanger protrusion 224 can mate securely with the hanging opening 222 for mounting the vertical basket 216 onto the inside of the body 102.

The vertical basket 216 can be attached to one side within the body 102 while the skewer 202 can extend parallel to and across an opposite side within the body 102. The grating 218 can be parallel to the skewer 202 for providing an evenly distributed heat to the food product 208 from the ignited fuel source 212.

Between the skewer 202 and the grating 218 of the vertical basket 216 a gap 226 is depicted. The gap 226 is contemplated to be the same size near the hole 204 of the body 102 and near the guide 212 of the body 102.

The vertical basket 216 holds the ignited fuel source 212 vertically within the vertical basket 216 providing a large cross section or area of the ignited fuel source 212 for providing cooking heat to the food product 208. The vertical placement of the skewer 202 is depicted to be centered within the vertical basket 216 for even heating of the food product 208.

It has been discovered that placing the vertical basket 216 on the side of the skewer 202 and out of the path of oils and juices from the cooking process, uncontrolled flare ups are avoided yielding better cooking results and less labor involved with cooking the food product since uncontrolled flare-ups from a bottom heat source are mitigated. It has further been discovered that implementing the vertical basket 216 with the grilling system 100 allows for the ignited fuel source 212 to be easily controlled, changed, and cleaned between use and further allows the grilling system 100 to be converted easily back to a more traditional grilling configuration.

The vertical basket 216 is shown to include spacers 228 to hold the vertical basket 216 up off a bottom floor of the body 102 and to expose a perforated bottom 230 of the vertical basket 216. Exposing the perforated bottom 230 allows air to evenly flow through the perforated bottom 230 and enter the vertical basket 216 where the air can be combusted with the ignited fuel source 212.

Below the food product 208 a removable pan 232 is depicted. The removable pan 232 can collet the oils and juices cooked out of the food product 208 for basting, sauce creation or for easier cleanup. Alternatively it is contemplated that the removable pan 232 could be excluded and the oils and juices cooked out of the food product 208 could be allowed to fall down into the body 102 of the grilling system 100 and away from the ignited fuel source 212.

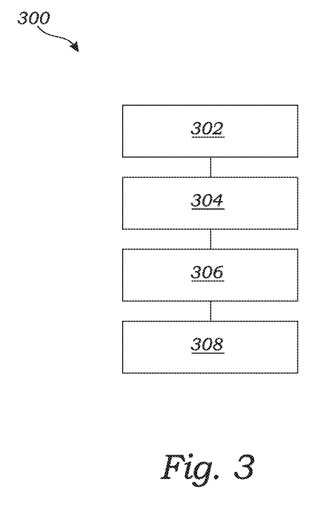

Referring now to FIG. 3, therein is shown a block diagram 300 for a method of manufacturing the grilling system. The method can include providing a body having an inner surface, a bottom floor, and a hole in a block 302; mounting a vertical basket having a spacer and an exposed perforated bottom the perforated bottom exposed from the bottom floor of the body by the spacer, the vertical basket further including a vertical grating and a solid back, the vertical basket for holding an ignited fuel source and radiating heat through the grating in a block 304; mounting a skewer parallel to the grating, the skewer including a bracket for securing a food product to the skewer in a block 306; and coupling a rotisserie motor to the body and to the skewer with the skewer extending through the hole in a block 308.

Thus, it has been discovered that the grilling system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the grilling system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A grilling system comprising:
a body having an inner surface and a bottom floor;
a vertical basket having a spacer and an exposed perforated bottom the perforated bottom exposed from the bottom floor of the body by the spacer, the vertical basket further including a vertical grating and a solid back, the vertical basket for holding an ignited fuel source and radiating heat through the grating; and
a skewer parallel to the grating, the skewer including a bracket for securing a food product to the skewer.

2. The system of claim 1 further comprising a rotisserie motor coupled to the body and to the skewer for rotating the skewer.

3. The system of claim 1 further comprising a removable pan over the bottom floor of the body.

4. The system of claim 1 wherein:
the body includes a guide; and
the skewer includes a groove resting in the guide.

5. The system of claim 1 wherein the ignited fuel source is charcoal or wood.

6. A grilling system comprising:
a body having an inner surface, a bottom floor, and a hole;
a vertical basket having a spacer and an exposed perforated bottom the perforated bottom exposed from the bottom floor of the body by the spacer, the vertical basket further including a vertical grating and a solid back, the vertical basket for holding an ignited fuel source and radiating heat through the grating;
a skewer parallel to the grating, the skewer including a bracket for securing a food product to the skewer; and
a rotisserie motor coupled to the body, the skewer extending through the hole and coupling with the rotisserie motor.

7. The system of claim 6 wherein the body further includes adjustable input vents for controlling an amount of air that can be input into the grilling system.

8. The system of claim 6 wherein the body has a round shape, a square shape, or a rectangular shape when viewed from a top.

9. The system of claim 6 further comprising a hood covering coupled to the body.

10. The system of claim 6 wherein the skewer is centered vertically with respect to the grating.

11. A method of manufacturing a grilling system comprising:
providing a body having an inner surface and a bottom floor;
mounting a vertical basket to the body, the vertical basket having a spacer and an exposed perforated bottom the perforated bottom exposed from the bottom floor of the body by the spacer, the vertical basket further including a vertical grating and a solid back, the vertical basket for holding an ignited fuel source and radiating heat through the grating; and
mounting a skewer to the body parallel to the grating, the skewer including a bracket for securing a food product to the skewer.

12. The method of claim 11 further comprising coupling a rotisserie motor to the body and to the skewer for rotating the skewer.

13. The method of claim 11 further comprising providing a removable pan over the bottom floor of the body.

14. The method of claim 11 wherein:
providing the body includes providing the body having a guide; and
mounting the skewer includes mounting the skewer having a groove resting in the guide.

15. The method of claim 11 wherein mounting the vertical basket for holding the ignited fuel source includes mounting the vertical basket for holding charcoal or wood.

16. The method of claim 11:
wherein providing the body includes providing the body further having a hole; and
further comprising coupling a rotisserie motor to the body and to the skewer with the skewer extending through the hole in the body to the rotisserie motor.

17. The method of claim 16 wherein the providing the body further includes providing the body having adjustable input vents for controlling an amount of air that can be input into the grilling system.

18. The method of claim 16 wherein the providing the body includes providing the body having a round shape, a square shape, or a rectangular shape when viewed from a top.

19. The method of claim 16 further comprising coupling a hood covering to the body.

20. The method of claim 16 wherein the mounting the skewer includes mounting the skewer centered vertically with respect to the grating.
